(19) United States
(12) Patent Application Publication
(10) Pub. No.: US 2025/0364569 A1
(43) Pub. Date: Nov. 27, 2025

(54) LIQUID SEMIMETAL ALPHA VOLTAIC CELL FOR DIRECT ENERGY CONVERSION

(71) Applicant: Avalanche Energy Designs Inc., Seattle, WA (US)

(72) Inventors: Daniel Velazquez, Seattle, WA (US); Daniel Merthe, Seattle, WA (US); Robin Langtry, Seattle, WA (US)

(73) Assignee: Avalanche Energy Designs Inc., Seattle, WA (US)

(21) Appl. No.: 19/217,905

(22) Filed: May 23, 2025

Related U.S. Application Data
(60) Provisional application No. 63/651,332, filed on May 23, 2024.

(51) Int. Cl. H01M 4/66; C25D 3/48; C25D 5/02; C25D 7/12; G21H 1/00; H01M 4/04; H01M 4/36; H01M 4/38; H01M 6/14

(52) U.S. Cl. CPC H01M 4/667; C25D 3/48; C25D 5/022; C25D 7/123; G21H 1/00; H01M 4/045; H01M 4/366; H01M 4/38; H01M 4/662; H01M 6/14; H01M 2300/002

(57) ABSTRACT

An alpha voltaic device for generating electrical power from the decay of alpha particles is provided. The device includes a substrate; an anode disposed on the substrate having an anode pad, a primary anodic electrode, and at least two branch anodic electrodes; a cathode disposed on the substrate having a cathode pad, a primary cathodic electrode, and at least two branch cathodic electrode; and an electrolytic semimetal deposited on the anode and cathode. The branch cathodic electrodes can extend toward the primary anodic electrode, and the branch anodic electrode can extend toward the primary cathodic electrode. Each of the branch anodic and branch cathodic electrodes can be interdigitated. The anode and cathode can be formed from gold (Au) and the electrolytic semimetal can be gallium (Ga). A process for manufacturing the alpha voltaic device using a photoresist mask is also provided.

### BACKGROUND

An alpha voltaic cell is a type of nuclear battery that generates electrical power from the decay of radioactive isotopes, specifically alpha particles. These devices typically consist of a radioactive source, an electrolytic medium, and two electrodes. When alpha particles emitted from the source enter the electrolytic medium, they ionize atoms and produce electrical current between the electrodes. Alpha voltaic cells have several potential applications, including remote or harsh environments where traditional power sources are impractical, long-term missions in space, and low-power electronics. They can also be used in conjunction with alpha producing fusion reactors for power generation and as backup power sources for critical systems. The efficiency of alpha voltaic cells can be improved by using materials with high alpha particle absorption and ionization capabilities, such as certain metals and semiconductors.

In a conventional solid-state device, the impingement of high-energy alpha particles leads to radiation damage, in the form of atomic displacement and swelling, which lead to a number of derivative failure modes, all of which ultimately limit the efficiency and lifetime of the device. Further, helium (He) bubbling is an issue with conventional alpha voltaic devices, which can cause embrittlement in solids. Accordingly, alpha voltaic devices, methods of using alpha voltaic devices, and methods of making alpha voltaic devices with reduced impingement and He bubbling are needed.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows an alpha voltaic device, in accordance with embodiments of the present disclosure;

FIGS. 2A-10 show a process of manufacturing the alpha voltaic device of FIG. 1, in accordance with embodiments of the present disclosure; and

FIGS. 11A-11C are perspective and detail views of the electrodes of an alpha voltaic device shown without the substrate of FIG. 10, in accordance with embodiments of the present disclosure.

### DETAILED DESCRIPTION

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

The present disclosure relates to the field of alpha voltaic devices, and more specifically, alpha voltaic nuclear battery devices that generate electrical power from the decay of radioactive isotopes, specifically alpha particles. In these devices, when alpha particles are emitted from the source and enter the electrolytic medium, the alpha particles ionize atoms and produce electrical current between the electrodes.

Embodiments of the alpha voltaic device described herein use electrodes of dissimilar work function as the cathode and anode, respectively, flanking a liquid gallium (Ga) medium. As a result of the work function difference between the cathode and anode, a voltage is induced, and a current proportional to the alpha source activity flows between the electrodes. Liquid Ga can be used as the electrolytic medium as it is a semimetal in the liquid state, which has a significantly lower conductivity than other transition metals while still conducting better than a semiconductor. The use of liquid Ga in the embodiments disclosed herein also leads to a more moderate recombination rate than in metals, thus potentially inducing a voltage between adjacent electrodes as ionization from alpha particles charges the junction, generating an electromotive force. This follows from the implementation of a high-activity alpha source, as is the case of a fusion reactor, which provides the ability to overcome the recombination rate given: (i) the greater electron-hole pair production rate; and (ii) the cell geometry, which is tuned to allow for optimum charge carrier transport.

The embodiments of the present disclosure are expected to provide several advantages over current technology devices. For example, one advantage of a liquid semimetal implementation versus a solid-state energy conversion medium is self-healing. In the embodiments disclosed herein using semimetallic Ga as the energy-conversion medium, radiation damage (e.g., microstructural deformations) can be averted by operating it above 300 K, a temperature at which Ga is in the liquid phase. In the liquid phase of Ga, long range coherence becomes irrelevant. In addition to mitigating radiation damage, the embodiments described herein also are expected to overcome the issue of helium (He) bubbling, which is achieved by implementing a cell configuration in which the free surface of Ga is exposed to the vacuum vessel, which allows for the release of He gas. In addition, the relatively high viscosity of Ga up to temperatures in the hundreds of degrees Celsius discourages leakage based on the large surface tension of Ga at these viscosity levels.

Alpha voltaic devices of the present disclosure can have multiple electrode configurations, for example, a stacked configuration, an interdigitated structure, among others, as will be described below. In some embodiments, the anode of the device can be Lanthanum hexaboride (LaB₆) and the cathode can be platinum (Pt), which can maximize the output voltage of the cell. The output voltage is given by the following equation, which has a range of about 3-3.5 V for LaB₆ and Pt.

$${V}_{out} = ΔΦ / e$$

In any of the embodiments disclosed herein, an array of devices can be connected in series to modulate the output voltage to form a pixel. An array of pixels can be connected in parallel to modulate the output current/power to construct the overall lattice. The entire lattice assembly can be constructed on a substrate that can act as a liner for the diode region of a fusion generator. By implementing a grid-anode with high transparency, the alpha voltaic liner can be constructed of an insulating refractory material, the inner side of which can be used as the surface upon which the alpha voltaic lattice can be printed or deposited by means of available and mature and proven nanofabrication techniques such as PVD, CVD, photolithography, etc. In these embodiments, the outer face of the liner can be used for electrical contacts as well as heat sinking.

In testing the devices disclosed herein, ionization was modeled using SRIM 2013 for an incident beam of He ions (as surrogate for alpha particles) on two targets, the free surface of a 15 μm slab of Ga and the same slab covered with 2 μm of Pt. The objective was to obtain the depth and ionization profiles within the targets, as well as the fraction of surrogate alpha particles that resulted in ions, or the k factor the equation below.

$$η = kSL ΔΦ / {WE}_{α}$$

In comparing free Ga slabs and Ga slabs covered with 2 μm of Pt, most of the electron-hole pairs can be expected to be generated within the Ga medium, with a bimodal depth distribution due to the domains which are bare from Pt. These regions of electron-hole pair production are expected to serve as a bridge which may enhance carrier transport to the electrodes corresponding to their respective attractive potential. The k value for both instances is roughly 0.95, although, notably, a significant degree of ionization occurs within the Pt layer, which may result in degradation over time. This effect can, nonetheless, be mitigated by reducing the thickness of Pt or by choosing another suitable material with a lower stopping power.

Although experimental values for stopping power for Ga are not certain, a conservative estimate can be taken from the values for silicon (Si) within the range of 0.1 to 0.5 MeV/μm for 3.3 MeV alpha particles, while W for Ga is roughly 11 eV. In this estimate, taking the result of k=0.95 from above, as well as ΔΦ=3.5 eV (using an anode of LaB₆ and a cathode of Pt), and the Ga slab thickness L=15 μm, it is obtained for 3.3 MeV alpha particles a range of:

$$η ∈ ( 13.7 , 69.7 ) \%$$

with output power range of

$${P}_{out} = η {P}_{α} ∈ ( 4.4 , 21 \text{.8} ) kW$$

In one exemplary embodiment, the electrodes and Ga medium can be arranged in a stacked configuration with a top electrode having micro perforated foil, which contacts the liquid Ga beneath and is the alpha-particle-facing electrode. The micro perforations permit the eventual release of excess He bubbles.

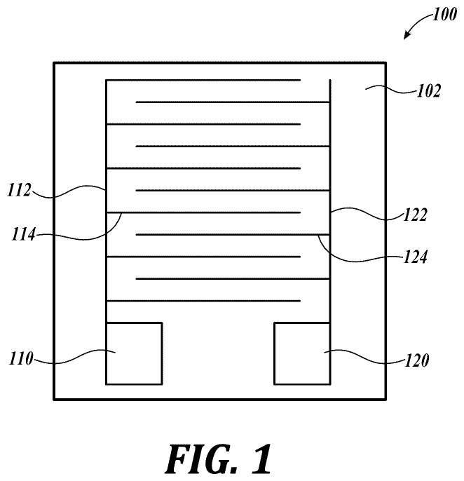

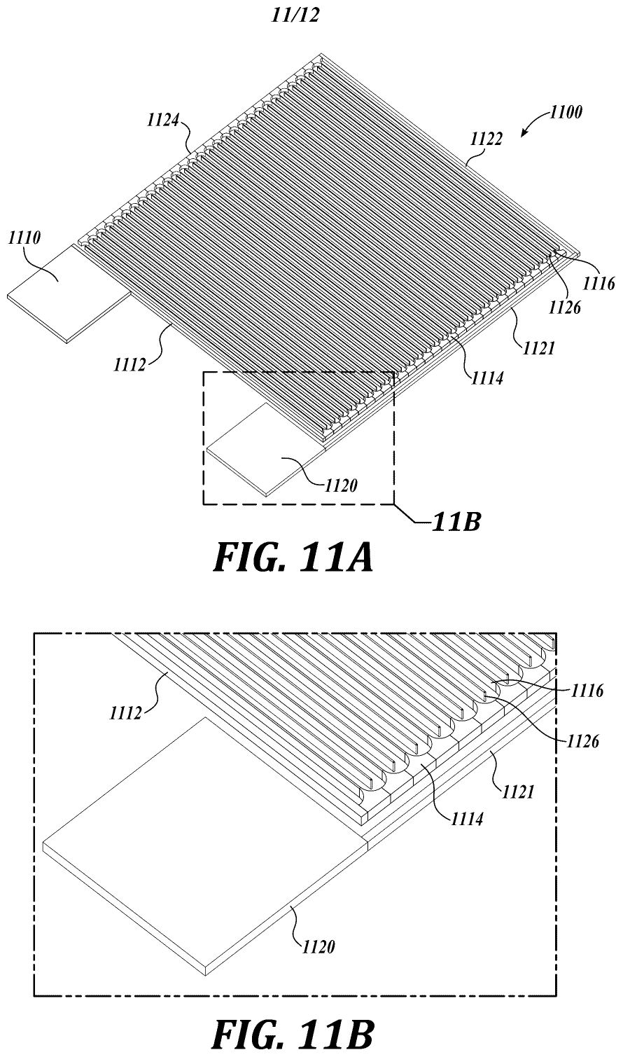

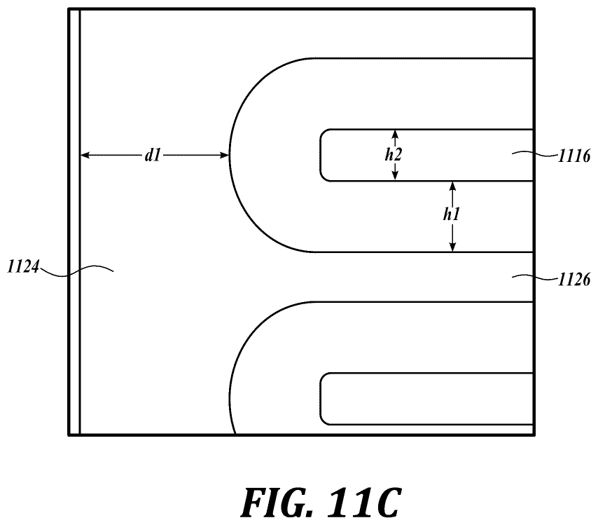

In another embodiment shown FIG. 1, an interdigitated structure of an alpha voltaic device 100 (“device 100”) is provided. The device 100 can have any suitable dimension and number of interdigitated electrodes. Accordingly, the configuration shown in FIG. 1 is simplified for clarity in the ensuing description. In an example, the interdigitated structure of FIG. 1 can be the configuration shown in FIG. 11A, with a relatively high density of interdigitated electrodes. The device 100 can include a substrate 102 (e.g. a silicon wafer) having thereon an anode pad 110 electrically coupled to a primary anodic electrode 112 and branch anodic electrodes 114, and a cathode pad 120 electrically coupled to a primary cathodic electrode 122 and branch cathodic electrodes 124. In the interdigitated configuration, the branch cathodic electrodes 124 extend toward the primary anodic electrode 112 and are interleaved between the branch anodic electrodes 124. In some embodiments, the device 100 can have an active area with the pads 110 and 120, the primary electrodes 112 and 122, and the branch electrodes of 114 and 124 of about 1 mm²; however, other sizes are within the scope of the present disclosure.

Embodiments of the device 100 can be manufactured using photolithography masks for direct-writing on electroplated wafers, electroplating, and other suitable manufacturing methods. One challenge associated with direct-writing the architecture of the device 100 includes the height of the electrodes. While micron-scale MEMS devices are achievable in straightforward processes using sputtering, the height of the electrodes of the device 100 (in an example, about 16 μm) required excessive deposition cycles.

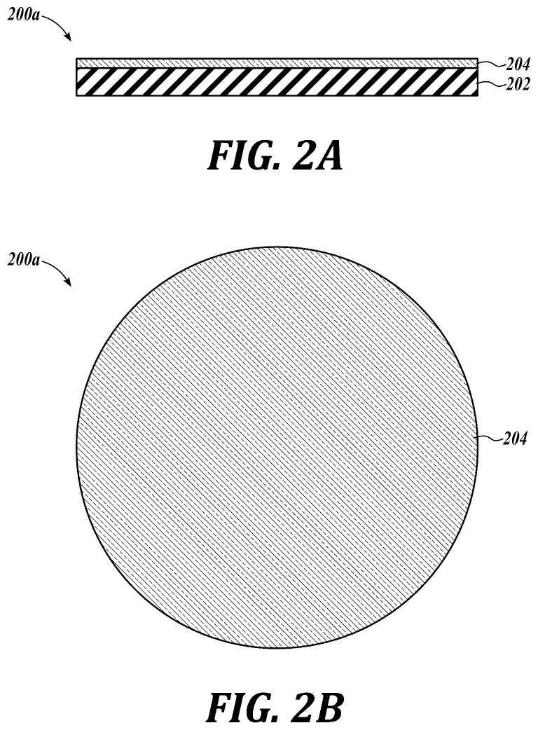

In some embodiments, the device 100 can be manufactured with electroplating with photoresist that can mask uniformly at the dimensions of the electrodes across a 4″ Si/SiO wafer. An exemplary sequence of process steps to form the device are shown in FIGS. 2A-10. Beginning in FIGS. 2A and 2B, a wafer 200 (designated 200a, 200b, 200c, etc. in each step of the process corresponding to those shown in FIGS. 2A-10) is obtained, which can be a silicon base 202 with an oxidation layer 204. The wafer 200a can be a standard 4″ wafer with a single side polish. During this step of the process, the thickness and the resistivity of the substrate 200a can be measured to ensure compliance with specifications.

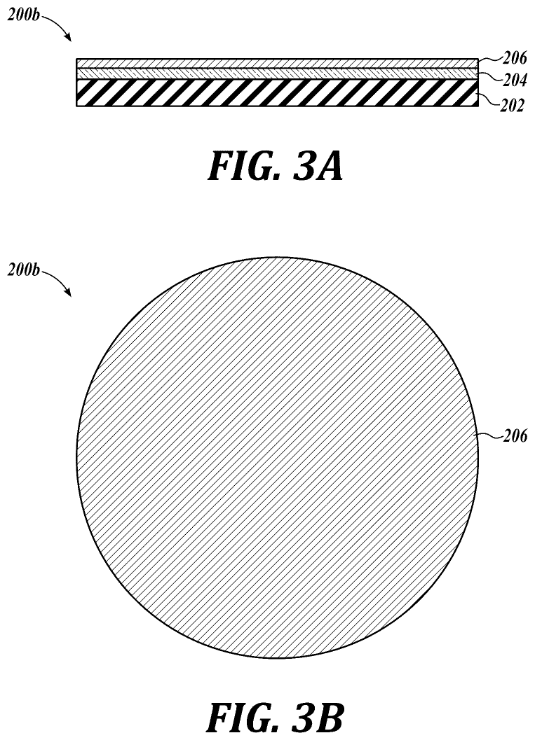

Next, in FIGS. 3A and 3B, the wafer 200b progresses as a seed titanium tungsten (TiW)/gold (Au)/TiW multilayer 206 is formed on the oxidation layer 204 by sputtering. In this case a sputter tool can create the alternating TiW/Au/TiW multilayer 206. In an example, the first TiW layer of the multilayer 206 can have a thickness of about 25 nm, the middle Au layer can have a thickness of about 180 nm, and the second TiW layer can have a thickness of about 25 nm. After the sputtering step of the wafer 200b, the sheet resistance of the seed multilayer 206 can be measured for compliance with specifications.

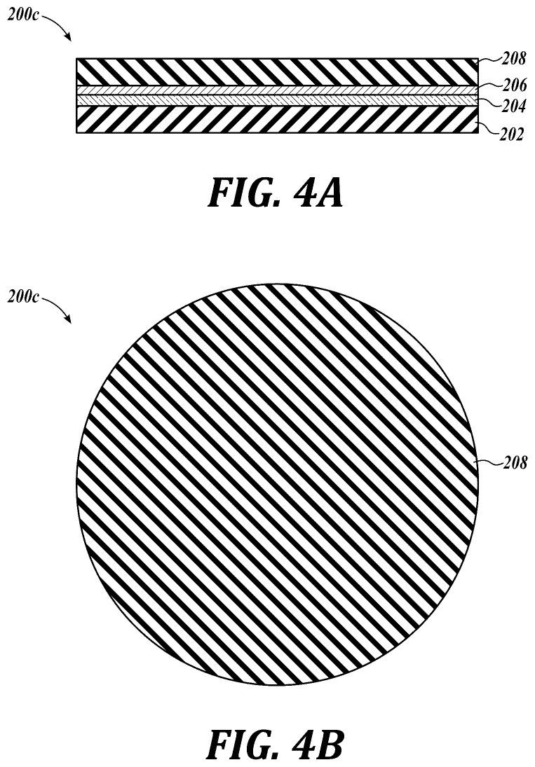

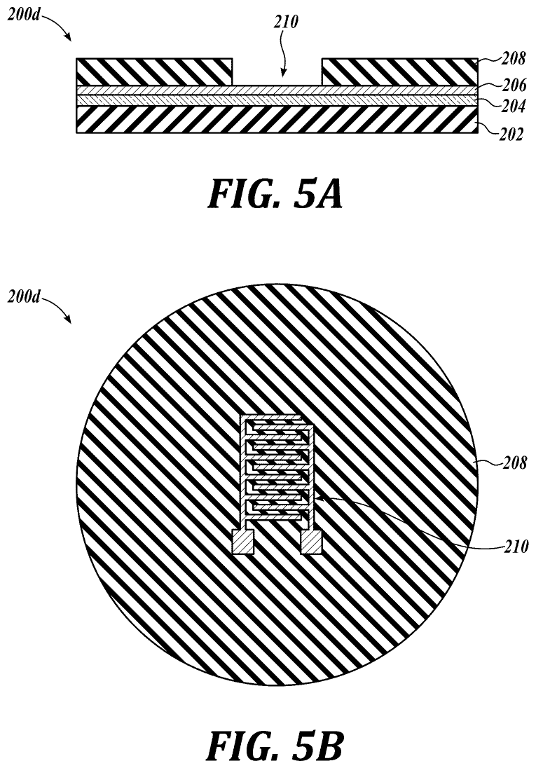

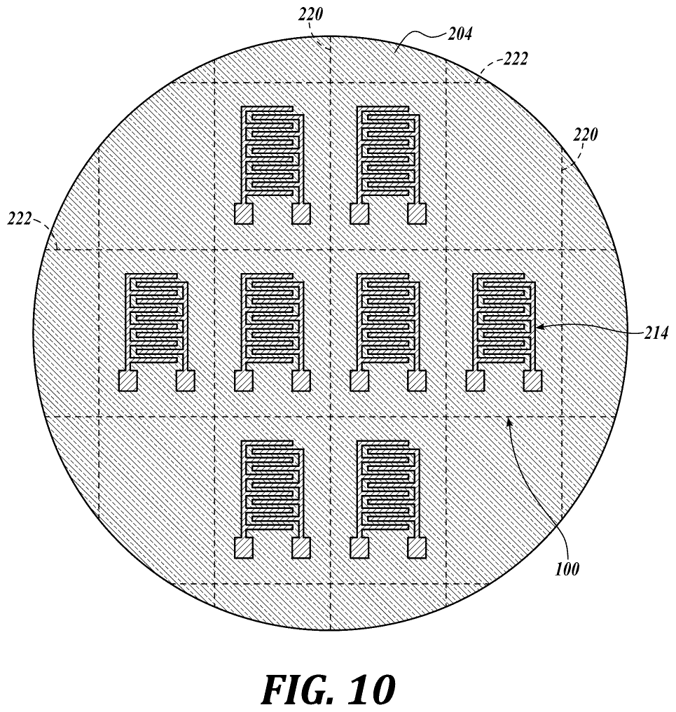

Next, in FIGS. 4A and 4B, the wafer 200c progresses as a photoresist layer 208 is formed on the seed TiW/Au/TiW multilayer 206. Next, in FIGS. 5A and 5B, the wafer 200d progresses as an exposed/developed area 210 is formed in the photoresist layer 208 with the configuration of the anode, cathode, and electrodes (e.g., the anode, cathode, and electrodes of the device 100). Although a single developed area 210 is shown in FIGS. 5A and 5B and other figures herein, the wafer 200d is configured to include a plurality of developed areas 210 for forming multiple devices 100 on the wafer 200d, such as shown in FIG. 10. In the following figure descriptions, only a single developed area 210 is shown for clarity in the figures. During the expose/develop step of FIGS. 5A and 5B, critical dimensions can be measured using an optical scope and the resist thickness can be measured using a profilometer.

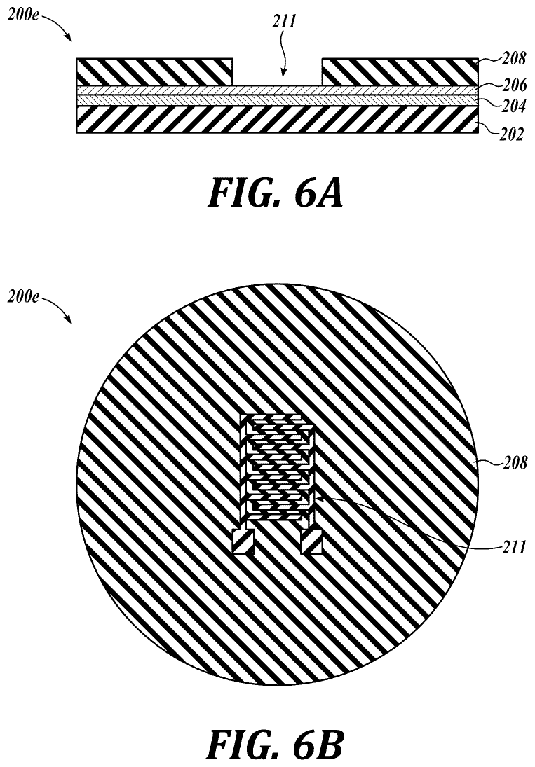

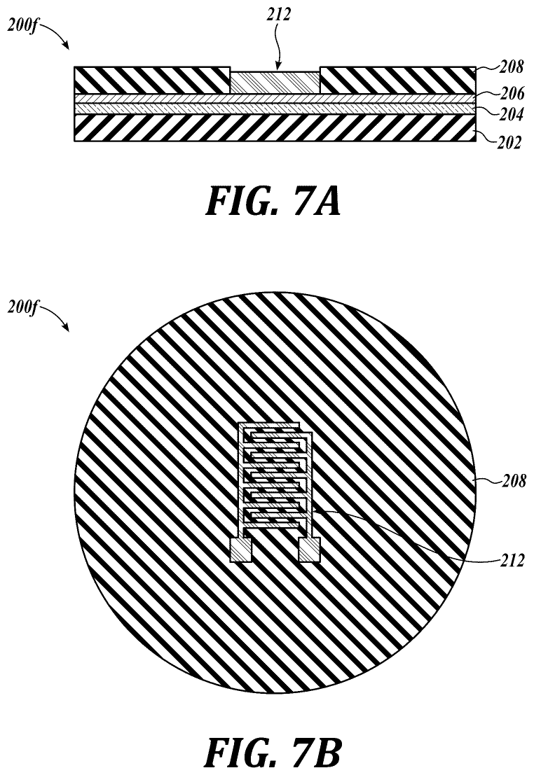

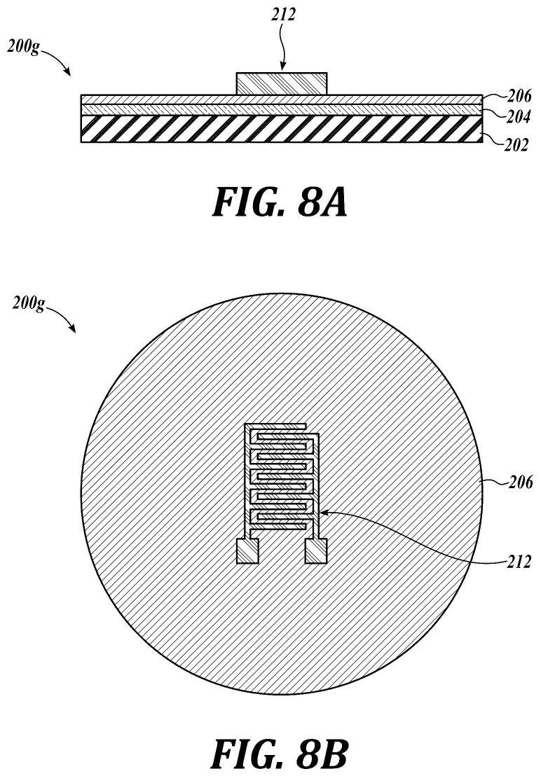

Next, in FIGS. 6A and 6B, the wafer 200e progresses with a step of etching the second, upper layer of TiW in the multilayer 206 to form an etched surface 211. The TiW can be etched using acetic acid and ammonium acetate. After the etching of the multilayer 206, in FIGS. 7A and 7B, the wafer 200f progresses with a step of electroplating Au material 212 on top of the etched surface 211. Next, in FIGS. 8A and 8B, the wafer 200g progresses by stripping the photoresist layer 208, exposing the second, upper layer of TiW in the multilayer 206. The step of stripping the photoresist layer 208 causes the Au material 212 of the device 100 to protrude outward from the multilayer 206.

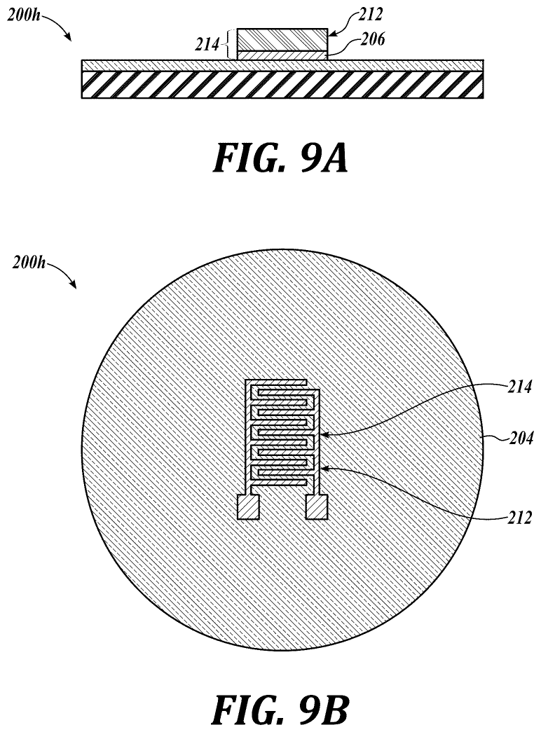

Next, in FIGS. 9A and 9B, the wafer 200h progresses with a step of etching away the multilayer 206 from the oxidation layer 204, leaving only the multilayer material 206 underneath the Au material 212 and forming a stack 214. As shown in FIG. 10, each of these stacks 214 can be arranged across the surface of the wafer 200 in a pattern allowing multiple devices 100 to be diced from a single wafer 200. In this regard, the wafer 200 can include vertical dicing streets 220 and horizontal dicing streets 222 along which the wafer 200 can be diced for die singulation. Cutting along the dicing streets 220 and 222 provides separation of each device 100 from the wafer 200.

The result of the process steps of FIGS. 2A-10 produces a batch of devices 100 that can be tested and further processed. Before or after the devices 100 are separated during the dicing step of FIG. 10, the Ga is incorporated by depositing a wetting layer via thermal evaporation (e.g., about a 100 nm wetting layer). Following the thermal evaporation step, Ga conformally coats the active region of the device 100, such that the device 100 can be implemented into systems to generate electrical power from the decay of alpha particles.

FIGS. 11A-11C are perspective and detail views of the electrodes of an alpha voltaic device 1100 (“device 1100”) shown without the substrate (layers 202 and 204 of FIG. 10). FIGS. 11A-11C are intended to depict one example of an anode, cathode, and electrode configuration for use with the devices of the present disclosure. Although one configuration is shown by way of example, other configurations are also within the scope of the present disclosure. The device 1100 can include an anode pad 1110, a lateral anodic electrode 1112, a primary anodic electrode 1114, and branch anodic electrodes 1116. The device 1100 further includes a cathode pad 1120, a vertical cathodic electrode 1121, a lateral cathodic electrode 1122, a primary cathodic electrode 1124, and branch cathodic electrodes 1126. As shown, the branch cathodic electrodes 1126 extend toward the primary anodic electrode 1114 and are interleaved between the branch anodic electrodes 1116. It will be appreciated that the lateral electrodes 1112 and 1122 cause the anode pad 1110 and its primary anodic electrode 1114 to be on opposite sides of the device 1100, and similarly, cause the cathode pad 1120 and its primary cathodic electrode 1124 to be on opposite sides of the device 1100. FIG. 11B shows a detail view of the interdigitated structure of the branch electrodes 1116 and 1126.

As set forth above, the spacing between the branch electrodes 1116 and 1126, and the width of the electrodes can be controlled to meet specification requirements. As shown, the height h1 of the gap between the branch anodic electrode 1116 and the branch cathodic electrode 1126 can be specified such that the device has the desired electrical power output when used within a system. Similarly, the height h2 of each of the branch electrodes 1116 and 1126 can be specified such that the device has the desired electrical power output when used within a system. In some embodiments, the device 1100 can have of a characteristic length (electrode depth h2 and separation h1) of about 16 μm+2 μm. The device 1100 can also include a width dl of the primary electrodes 1114 and 1124.

In some embodiments, the devices 100 and 1100 can be a Ga converter where the converting medium is Ga. In other embodiments, the devices 100 and 1100 can include a Si alpha detector, where the converting medium is Si. The Si alpha detector can be used to determine the efficacy of collecting a signal from an ion gun. This data can then be used for comparison with the Ga converter as well as model feedback.

These embodiments are capable of performing conversion testing with low energy ions (25-30 keV) for model validation. In this regard, the feature size is tuned for lower charge carrier transport with different electrode widths (e.g., 5 μm, 10 μm, 20 μm, etc.) to correlate conversion efficiency with transparency. In the embodiments disclosed herein, the device can include Ga-tolerant materials (such as a TiW alloy).

In the foregoing description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 10% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. An alpha voltaic device, comprising:
a substrate;
an anode disposed on the substrate and comprising:
an anode pad;
a primary anodic electrode electrically coupled to the anode pad; and
at least two branch anodic electrodes electrically coupled to the primary anodic electrode;
a cathode disposed on the substrate and comprising:
a cathode pad;
a primary cathodic electrode electrically coupled to the cathode pad; and
at least two branch cathodic electrode electrically coupled to the primary cathodic electrode; and
an electrolytic semimetal deposited on the anode and cathode,
wherein the at least two branch cathodic electrodes extend toward the primary anodic electrode, wherein the at least two branch anodic electrode extend toward the primary cathodic electrode, and wherein each of the branch anodic and branch cathodic electrodes are interdigitated.

2. The alpha voltaic device of claim 1, wherein the electrolytic semimetal is gallium (Ga).

3. The alpha voltaic device of claim 1, wherein the anode and cathode are formed from gold (Au), and wherein the substrate is a silicon wafer.

4. The alpha voltaic device of claim 3, wherein a multilayer of titanium tungsten (TiW), gold (Au), and titanium tungsten (TiW) is disposed between the substrate and both the anode and the cathode.

5. The alpha voltaic device of claim 1, wherein the anode further comprises a lateral anodic electrode electrically coupled to and extending between the anode pad and the primary anodic electrode, wherein the primary anodic electrode is positioned adjacent to the cathode pad.

6. The alpha voltaic device of claim 5, wherein the cathode further comprises a vertical cathodic electrode electrically coupled to the cathode pad and a lateral cathodic electrode electrically coupled to and extending between the vertical cathodic electrode and the primary cathodic electrode, wherein the primary cathodic electrode is positioned adjacent to the anode pad.

7. The alpha voltaic device of claim 1, wherein the primary anodic electrode is on the same lateral side of the alpha voltaic device as the anode pad, and wherein the primary cathodic electrode is on the same lateral side of the alpha voltaic device as the cathode pad.

8. The alpha voltaic device of claim 1, wherein the depth of the at least two branch anodic electrodes and the at least two branch cathodic electrodes is about 14 μm to about 18 μm.

9. The alpha voltaic device of claim 1, wherein the separation between each of the at least two branch anodic electrodes from each of the at least two branch cathodic electrodes is about 14 μm to about 18 μm.

10. The alpha voltaic device of claim 1, wherein the width of the at least two branch anodic electrodes and the at least two branch cathodic electrodes is about 5 μm to about 20 μm.

11. A method of manufacturing an alpha voltaic device, comprising:
obtaining a wafer having a silicon base and an oxidation layer;
forming a seed multilayer on the oxidation layer, the seed multilayer comprising a first layer on the oxidation layer, a second layer on the first layer, and a third layer on the second layer;
applying a photoresist material on the third layer of the seed multilayer;
exposing the photoresist material to form a pattern through the photoresist material;
etching the third layer of the seed multilayer within the pattern formed in the photoresist material;
electroplating conductive material on top of the etched surface, the conductive material forming the anode and cathode of the alpha voltaic device based on the pattern;
stripping the remaining photoresist material off of the third layer of the seed multilayer;
etching away the seed multilayer from the oxidation layer;
depositing an electrolytic semimetal on the anode and cathode; and
dicing the wafer to singulate the alpha voltaic device.

12. The method of claim 11, wherein electrolytic semimetal is gallium (Ga) deposited using thermal evaporation.

13. The method of claim 11, wherein the seed multilayer comprises titanium tungsten (TiW) as the first layer, gold (Au) as the second layer, and titanium tungsten (TiW) as the third layer.

14. The method of claim 13, wherein the conductive material is gold (Au).

15. The method of claim 13, wherein the first layer of titanium tungsten (TiW) has a thickness of about 25 nm, the second layer of gold (Au) has a thickness of about 180 nm, and the third layer of titanium tungsten (TiW) has a thickness of about 25 nm.

16. The method of claim 11,
wherein the anode comprises:
an anode pad;
a primary anodic electrode electrically coupled to the anode pad; and
at least two branch anodic electrodes electrically coupled to the primary anodic electrode, and
wherein the cathode comprises:
a cathode pad;
a primary cathodic electrode electrically coupled to the cathode pad; and
at least two branch cathodic electrode electrically coupled to the primary cathodic electrode.

17. The method of claim 16, wherein the at least two branch cathodic electrodes extend toward the primary anodic electrode, wherein the at least two branch anodic electrode extend toward the primary cathodic electrode, and wherein each of the branch anodic and branch cathodic electrodes are interdigitated.

18. The method of claim 17, wherein the primary anodic electrode is on the same lateral side of the alpha voltaic device as the anode pad, and wherein the primary cathodic electrode is on the same lateral side of the alpha voltaic device as the cathode pad.

19. The method of claim 17, wherein the depth of the at least two branch anodic electrodes and the at least two branch cathodic electrodes is about 14 μm to about 18 μm, and wherein the separation between each of the at least two branch anodic electrodes from each of the at least two branch cathodic electrodes is about 14 μm to about 18 μm.

20. The method of claim 11, wherein dicing the wafer singulates at least two alpha voltaic devices.
